(19) United States
(12) Patent Application Publication
(10) Pub. No.: US 2023/0347302 A1
(43) Pub. Date: Nov. 2, 2023

(54) Carbon Nanotube Based Membrane and Methods of Manufacturing

(71) Applicant: Atom H2O, LLC, Escondido, CA (US)

(72) Inventor: Huaping Li, Los Angeles, CA (US)

(73) Assignee: Atom H2O, LLC, Escondido, CA (US)

(21) Appl. No.: 17/997,880

(22) PCT Filed: May 3, 2021
(86) PCT No.: PCT/US2021/030460

§ 371 Date: Nov. 3, 2022

Related U.S. Application Data
(60) Provisional application No. 63/019,940, filed on May 4, 2020.

(51) Int. Cl. B01D 69/14; B01D 71/02; B01D 71/56; B01D 71/64; B01D 69/12; B01D 69/10; B01D 69/02; B01D 67/00; B01D 63/10; B01D 61/02; C02F 1/44

(52) U.S. Cl. CPC B01D 69/148; B01D 71/0212; B01D 71/56; B01D 71/64; B01D 69/14111; B01D 69/1216; B01D 69/107; B01D 69/02; B01D 67/00793; B01D 63/101; B01D 61/025; C02F 1/441; B01D 2325/20; B01D 2323/216; C02F 2305/08; C02F 2103/10

(57) ABSTRACT

The present disclosure relates to carbon nanotube based desalination membranes and methods of manufacturing thereof. The carbon nanotube based desalination membranes may be manufactured by: providing a polymer matrix; providing carbon nanotubes directly contacting the polymer matrix; stirring the carbon nanotubes into the polymer matrix in order to make a carbon nanotube composite solution; and coating a substrate with the carbon nanotube composite solution to form a carbon nanotube desalination membrane. The carbon nanotube based desalination membranes may provide superior flow rate and high levels of salt rejection.

### CROSS-REFERENCE TO RELATED APPLICATIONS

This application claims the benefit of and priority under 35 U.S.C. § 119(e) to U.S. Provisional Patent Application Ser. No. 63/019,940 entitled “Carbon Nanotube Based Membrane for Desalination,” filed May 4, 2020, which is incorporated herein by reference in its entirety for all purposes.

### FIELD OF THE INVENTION

The present invention generally relates to carbon nanotube based desalination membranes and method of manufacturing thereof.

### BACKGROUND

The global water desalination market is set to reach USD 26.81 billion by 2025, driven by rapid industrialization, increasing population, and depleting freshwater bodies. Moreover, increasing public awareness regarding water conservation and strict government laws on treatment is expected to fuel growth. Recycled wastewater is widely used in landscaping and irrigation. The Middle East & Africa was the largest market accounting for 53% of the revenue share in 2016 and is expected to maintain its dominance over the forecast period on account of the high supply-demand gap of potable water.

Global warming has resulted in accelerating the evaporation of water bodies which eventually has led to droughts in numerous parts of the world. For instance, the U.S. and Middle East & Africa have been affected adversely by severe multi-year and multi-state droughts over the past few years.

Countries such as U.S. and Saudi Arabia are focusing on the existing projects, instead of commencing new projects. The North America desalination market is expected to grow at an 8.6% CAGR over the next few years on account of rising number of natural calamities which are resulting in depriving its population & industries of water. Companies are investing extensively in R&D to enhance technology. For instance, in April 2014, GE Corporation launched an open technology challenge to accelerate the development of technology to improve the efficiency of seawater desalination. In addition to this, the companies are concentrating on new projects. Further, in November 2014, Suez announced construction, design and operation of a desalination plant at new Mirfa Independent Water and Power Project in Abu Dhabi. Furthermore, Veolia has developed itself in both Multiple Effect Distillation and Reverse Osmosis to offer energy-efficient hybrid desalination technology to mark its presence in global market.

Currently organizations such as the US Army use iodine and chlor-floc treatment kits for emergency water purification. However, these systems may only be effective at disinfecting microbiological organisms in fresh water systems. The US Army Product Manager—Soldier Clothing and Individual Equipment has been developing an Individual Water Treatment Device (IWTD) with the goal of enabling soldiers to obtain emergency drinking water from any indigenous water source. The first increment of IWTD may be used for emergency water purification of microorganisms in fresh water sources. While the initial increment of IWTD may be microbiological purification of indigenous fresh water, it may be advantageous to purify water from any source (e.g. fresh water, brackish water, or seawater).

One drawback in developing a portable desalination unit is that the current commercial technologies for large-scale desalination generally do not scale-down very well to adequately serve the needs of individual water treatment systems. Large scale desalination benefits from vast amounts of power and produce a vast amount of highly concentrated brine at a high cost. Additionally, current commercially available personal desalination systems still remain costly and cannot meet certain requirements (e.g. weight, power, size).

### SUMMARY OF THE INVENTION

Various embodiments are directed to a filtration membrane including: a substrate; a polyamide layer, where the polyamide layer is configured to perform reverse osmosis; and carbon nanotubes, where the carbon nanotubes are either: in an interface between the substrate and the polyamide layer, inside the polyamide layer, or above the polyamide layer.

In various other embodiments, the carbon nanotubes are single-walled carbon nanotubes, double-walled carbon nanotubes, or multi-walled carbon nanotubes.

In still various other embodiments, the carbon nanotubes are single-walled carbon nanotubes.

In still various other embodiments, the carbon nanotubes are high pressure carbon monoxide conversion produced single-walled carbon nanotubes with smaller diameters and low-density lightweight powder.

In still various other embodiments, the substrate comprises polysulfonate.

In still various other embodiments, the polysulfonate comprises polyether sulfonate.

In still various other embodiments, the carbon nanotubes are deposited either on the polyamide layer or on the substrate by immersing the substrate or polyamide layer into a carbon nanotube aqueous solution.

In still various other embodiments, the carbon nanotube aqueous solution is stabilized by surfactants.

In still various other embodiments, the surfactants comprise anionic surfactants, cationic surfactants, or nonionic surfactants.

In still various other embodiments, the anionic surfactants comprise sodium dodecyl sulfate or sodium dodecylbenzene sulfonate.

In still various other embodiments, the cationic surfactants comprise quaternary ammonium.

In still various other embodiments, the nonionic surfactants comprise triton X-100.

In still various other embodiments, the carbon nanotubes inside the polyamide layer are formed by: dissolving m-phenylene diamines in a carbon nanotube solution to form a compound solution, reacting the compound solution with trimesoyl chloride hexane to form the polyamide layer with incorporated carbon nanotubes.

In still various other embodiments, the filtration membrane is used for reverse osmosis desalination of water, gas purification, and mining treatment.

In still various other embodiments, when the filtration membranes are used for reverse osmosis desalination of water, the filtration membranes achieve a 98% salt rejection and 50 Liters/m²/hour (LMH) flux in chlorinated and high temperature conditions.

Further, various embodiments are directed to a spiral wound element comprising: the filtration membrane described above, where the spiral wound element achieves 90% salt rejection when used for reverse osmosis desalination of water.

Further, various embodiments are directed to a filtration membrane including: a substrate; a carbon nanotube polymer composite formed on the substrate, wherein the carbon nanotube polymer composite comprises carbon nanotubes mixed into a polymer matrix.

In various other embodiments, the polymer matrix comprises polyimide.

In still various other embodiments, the polymer matrix further comprises the polyimide dissolved in n-methylpyrrolidone.

In still various other embodiments, the polymer matrix comprises polysulfonate.

In still various other embodiments, the polymer matrix further comprises polysulfonate dissolved in chloroform.

In still various other embodiments, the polysulfonate comprises polyethersulfonate.

In still various other embodiments, the carbon nanotube polymer composite is formed on the substrate through casting or blade depositing.

In still various other embodiments, the substrate comprise polyester.

In still various other embodiments, the polyester comprises polypropylene or polyethylene.

In still various other embodiments, the filtration membrane further includes a polyamide layer disposed over the carbon nanotube polymer composite.

In still various other embodiments, the carbon nanotubes are high pressure carbon monoxide conversion produced single-walled carbon nanotubes with smaller diameters and low-density lightweight powder.

Further, various embodiments are directed to a method for forming a filtration membrane including: providing a polymer matrix; providing carbon nanotubes, wherein the carbon nanotubes directly contact the polymer matrix; mixing the carbon nanotubes into the polymer matrix in order to make a homogenous carbon nanotube composite solution; and coating a substrate with the carbon nanotube composite solution to form a carbon nanotube desalination membrane.

In various other embodiments, the polymer matrix comprises polyimide.

In still various other embodiments, the polyimide comprises m-diaminophenylene.

In still various other embodiments, the polymer matrix further comprises n-methylpyrrolidone.

In still various other embodiments, the substrate comprises polyester.

In still various other embodiments, the substrate comprises polypropylene or polyethylene.

In still various other embodiments, the polymer matrix comprises polysulfone.

In still various other embodiments, the polymer matrix further comprises chloroform.

In still various other embodiments, the substrate comprises polyester.

In still various other embodiments, the substrate comprises polypropylene or polyethylene.

In still various other embodiments, the carbon nanotubes are synthesized using a high pressure carbon monoxide process.

In still various other embodiments, the carbon nanotubes are single walled carbon nanotubes.

In still various other embodiments, the single walled carbon nanotubes include a small diameter.

In still various other embodiments, the homogenous carbon nanotube composite solution comprises a slurry.

In still various other embodiments, the method further includes applying a polyamide coating after coating the substrate with the carbon nanotube desalination solution.

In still various other embodiments, the substrate comprises a tricot film.

Further, various embodiments are directed to a method for forming a desalination device including: forming a desalination membrane with the steps discussed above; winding the desalination membrane into a spiral membrane wound element; and installing the spiral membrane wound element into a desalination cartridge.

Further, various embodiments are directed to a method for forming a filtration membrane including: dunking a substrate into a carbon nanotube aqueous solution to form a carbon nanotube layer, wherein either the substrate is coated with a polyamide layer before dunking the substrate into the carbon nanotube aqueous solution, a polyamide layer is applied on top of the carbon nanotube layer.

In various other embodiments, carbon nanotubes in the carbon nanotube aqueous solution are high pressure carbon monoxide conversion produced single-walled carbon nanotubes with smaller diameters and are low-density lightweight powder.

In still various other embodiments, the substrate comprises polysulfonate.

In still various other embodiments, the carbon nanotube aqueous solution is stabilized by surfactants.

In still various other embodiments, the surfactants comprise anionic surfactants, cationic surfactants, or nonionic surfactants.

In still various other embodiments, the anionic surfactants comprise sodium dodecyl sulfate or sodium dodecylbenzene sulfonate.

In still various other embodiments, the cationic surfactants comprise quaternary ammonium.

In still various other embodiments, the nonionic surfactants comprise triton X-100.

Further, various embodiments are directed to a method of forming a filtration membrane including: dissolving m-phenylene diamines in a carbon nanotube solution to form a compound solution; reacting the compound solution on a substrate with trimesoyl chloride hexane to form a polyamide layer with incorporated carbon nanotubes on the substrate.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1A is an example structure for single walled carbon nanotubes.

FIG. 1B is a schematic of a carbon nanotube based desalination membrane in accordance with an embodiment of the invention.

FIG. 2 is a plot of flow results from a carbon nanotube based desalination membrane.

FIGS. 3A-3C are various sequential images a process of producing a carbon nanotube polymer mixture in accordance with an embodiment of the invention.

FIG. 4 is various photographic images of fabricated carbon nanotube based desalination membranes on various substrates.

FIG. 5A is an example SEM image of a carbon nanotube based desalination membrane.

FIG. 5B is a FIB image on a cross section of a carbon nanotube based desalination membrane.

FIG. 6A is a diagram of an example membrane test system.

FIG. 6B is an image of an example membrane test system as illustrated in the diagram of FIG. 6A.

FIG. 7A is an example spiral wound element and a desalination cartridge integrated with a carbon nanotube based desalination membrane in accordance with an embodiment of the invention.

FIG. 7B is various images of a desalination cartridge integrated with a carbon nanotube based desalination membrane in accordance with an embodiment of the invention.

FIG. 7C is an example individual desalination device installed with the desalination cartridge illustrated in FIGS. 7A and 7B.

FIG. 8A is a vis-NIR absorption spectrum of an as prepared SWCNT ink (indicated by (6,5) arrows) with enriched (6,5) SWCNT according to one or more embodiments of the invention and a SWCNT solution prepared using a conventional high pressure carbon monoxide process, according to one or more embodiments.

FIG. 8B is a photo image of 100 mL ink containing electronically pure (6,5) SWCNTs with concentration of 0.6 m/mL, according to one or more embodiments.

FIG. 8C is vis-NIR absorption spectrum (solid curve) and NIR fluorescence emission spectrum (dashed curve, excited at 532 nm) of the electronically pure (6,5) SWCNT ink of FIG. 8B, according to one or more embodiments.

FIG. 8D is a Raman Spectrum of the electronically pure (6,5) SWCNT ink of FIG. 8B, excited at 532 nm laser beam, according to one or more embodiments; the enlarged RBM peak band at 310 cm′ is shown in the insert box.

### DETAILED DESCRIPTION

Traditionally, thermal desalination has been one of the most reliable techniques for water desalination. Multi-stage flash distillation can produce purer water to which minerals are added to enhance the taste of water. The market for multi-stage filtration is expected to grow at an 8.4% compound annual growth rate (CAGR) during the forecast period owing to its high purity yield compared to reverse osmosis. None of these desalination techniques may be used as a man portable or man powered unit.

Reverse osmosis is expected to witness the fastest growth on account of its lower energy consumption rates. Rising need for pure water in chemical and food industries is projected to boost the market for reverse osmosis over the forecast period and is estimated to be worth USD 15.43 billion by 2025. However, reverse osmosis may not produce the purity necessary for desalination.

Seawater contributed to 58.2% of the revenue share in 2016 for purified water, making it the largest source of purified water and the trend is expected to continue. Rapid industrialization and substantial investments regarding desalination in regions such as the Middle East are anticipated to drive the global market over the next few years.

To overcome current deficiencies in the current desalination technologies, the disclosed carbon nanotube based desalination devices may remove salts from seawater and/or brackish water sources to produce drinking water at a rate of 1 liter/hour/person with up to 9 people using carbon nanotube desalination membranes that either may not use external power or may use only minimal external power.

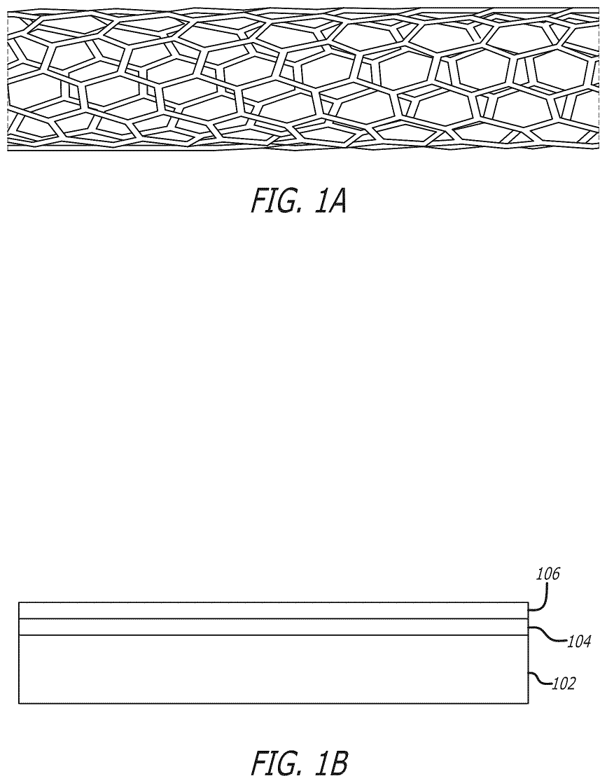

Light weight, low density and high strength carbon nanotube based desalination membranes may provide high water permeabilities and high ion rejections. In some embodiments, the desalination membranes may be integrated into desalination devices manufactured as small units for use by individual persons. In some embodiments, the desalination membranes may be integrated into desalination devices used in a desalination plant for commercial use. In some embodiments, the carbon nanotubes may be single walled carbon nanotubes (SWCNTs). An example structure for SWCNTs is illustrated in FIG. 1A. In some embodiments, the carbon nanotubes may be synthesized using high pressure carbon monoxide (HiPCO). Carbon nanotubes synthesized using HiPCO may have a smaller diameter than other methods of producing carbon nanotubes. The HiPCO carbon nanotubes may be of diameter between 0.6 nm to 1.6 nm or 0.7 nm to 1.2 nm. HiPCO carbon nanotubes may allow for high homogeneity in a resultant film which allows for better performance in films. The films may be created through roll to roll processing.

In some embodiments, the carbon nanotube based desalination membranes may be manufactured using a mixture of carbon nanotubes in a polymer solution. The polymer solution may include a polyimide precursor such as m-diaminophenylene. The polyimide precursor may be in n-methylpyrrolidone (NMG). In some embodiments, the polymer solution may be polysulfone (e.g. polyethersulfonate) in chloroform. The mixture of carbon nanotubes in a polymer solution may be coated on a polyester substrate. The polyester substrate may be polypropylene or polyethylene.

In some embodiments, after coating the mixture of carbon nanotubes in a polymer solution onto the polyester substrate, a polyamide coating may be formed on the carbon nanotube polymer coating. The polyamide coating may enhance the ion rejection characteristics of the carbon nanotube based desalination membranes. An example chemical structure of polyamide is illustrated below:

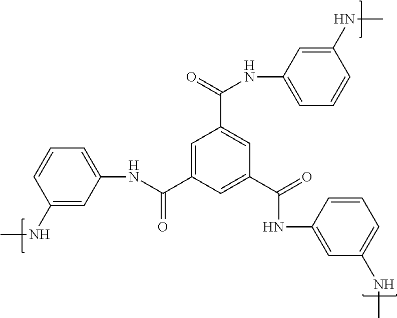

In some embodiments, the carbon nanotube based desalination membranes may be manufactured using a mixture of carbon nanotubes in an aqueous solution. The aqueous solution may include sodium dodecyl sulfonate. The sodium dodecyl sulfonate may be of 2% weight concentration. The mixture of carbon nanotubes in the aqueous solution may be coated on a polysulfone substrate. The polysulfone substrate may include polyestersulfone.

In some embodiments, a polyamide coating may be applied to the polysulfone substrate before coating the mixture of carbon nanotubes in the aqueous solution. In some embodiments, a polyamide coating may be applied on top of the coating of the mixture of carbon nanotubes in the aqueous solution. In some embodiments, the mixture of carbon nanotubes in aqueous solution may be mixed into a polymer matrix which may be applied to the polysulfone substrate. Advantageously, the small diameter of HiPCO carbon nanotubes allows the carbon nanotubes to adequately with the polymer matrix to form a slurry. A larger diameter of carbon nanotubes may not mix properly with the polymer matrix.

The carbon nanotubes may be homogeneously blended with a polymer matrix and facilely casted on a membrane such as tricot backed layers or a polysulfone substrate. The resultant carbon nanotube polymer membranes may be conductive and may electroporate the bacteria and virus, as well as provide bio-film fouling protection.

Various properties of the desalination devices including a carbon nanotube based desalination membranes may include one or more of:
Capability of desalinating 135 Liters per person (up to 9 people) before replacement of any of the elements and/or components.
Lightweight, with a total system weight of 16 ounces/person (up to 9 people maximum)—dry weight.
Man-portable.
Produce desalinated water at a flow rate of no less than 1 Liter/hour/person. Capable of surviving a 6 foot drop to concrete and 300 lbs dynamic and static compression while dry.
Be human powered or, if batteries or other electronic components are required, the battery or other electronic components are commercially available and included in the total system weight for the entire service life of the desalination device.
Capable of being used and operated with water temperatures from 4° C. to 49° C., in environments with temperature from −33° C. to 52° C.
Include a treat to drink time of less than 20 minutes with no more than 15 minutes/hour of hands-on time.
Be compatible with the current IWTD or provide microbiological purification in accordance with NSF Protocol P248.2.
Eliminate, or be compatible with, systems that remove chemical contamination (arsenic, chloride, cyanide, magnesium and sulfate).
System cost for one person should be <$200 at full scale manufacturing.

### Embodiments Including Mixtures of Carbon Nanotubes in a Polymer Solution

In some embodiments, a mixture of carbon nanotubes in a polymer solution may be applied to a polyester substrate. Polyester substrates are inexpensive substrates with relatively large micron sized pores which offer limited filtration on their own. The coating of carbon nanotubes in the polymer solution may enhance the filtration of the polyester substrates. The polymer solution may include a polyimide precursor such as m-diaminophenylene. Polyimide is a polymer of imide monomers belonging to the class of high performance plastics. Polyimide may have high heat-resistance. Polyimide may be used in diverse applications in roles demanding rugged organic materials, e.g. high temperature fuel cells, displays, and various military roles. An example chemical structure of polyimide is illustrated below:

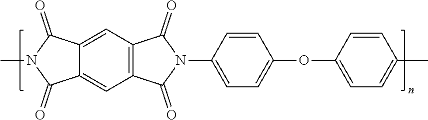

The polyimide precursor may be in n-methylpyrrolidone (NMG). In some embodiments, the polymer solution may include polysulfone (e.g. a polyethersulfone) in chloroform. In some embodiments, the mixture of carbon nanotubes in a polymer solution may be applied to the polyester substrate through a coating process suitable for coating a viscous solution onto a substrate such as blade coating. After the mixture of carbon nanotubes in a polymer solution is applied to the polyester substrate, the mixture of carbon nanotubes in the polymer solution may be dried to form a carbon nanotube polymer composite layer.

It was discovered that while a polysulfone substrate may have small pores (e.g. in the nanometer range), polysulfone substrates are typically more expensive than polyester substrates. Further, after coating the polysulfone substrates with the mixture of carbon nanotubes in the polymer solution, the resultant membrane would not flow. Using a polyester substrate coated with the mixture of carbon nanotubes in a polymer solution results in a high flow rate while allowing for high levels of ion rejection (salt reduction). In some tests, at a pressure of 700 psi a flow rate of 6 ml/minute was achieved with a 66.6% ion rejection of a 2000 ppm solution of magnesium sulfate.

It may be challenge to produce the mixture of carbon nanotubes in a polymer solution because polymer solutions tend to be viscous. It may be difficult to create a slurry of carbon nanotubes in a polymer solution using high diameter carbon nanotubes. When using high diameter carbon nanotubes, the resultant coating may be uneven which may produce poor results. Large diameter carbon nanotubes may include a diameter of greater than 2 nm, greater than 1.8 nm, greater than 1.6 nm, or greater than 1.4 nm. Carbon nanotubes made from HiPCO may include a small diameter and be advantageous for use in the mixture of carbon nanotubes in the polymer solution. Examples of HiPCO may be found in U.S. Pat. No. 6,761,870 entitled “Gas-phase nucleation and growth of single-wall carbon nanotubes from high pressure CO” and filed on Jul. 1, 2002 which is hereby incorporated by reference in its entirety. Small diameter carbon nanotubes may include a diameter of 0.6 nm to 1.6 nm or 0.7 nm to 1.2 nm. The carbon nanotubes may be HiPCO produced single-walled carbon nanotubes with smaller diameters which make up a low-density lightweight powder.

In some embodiments, the carbon nanotubes may be single-walled carbon nanotubes, double-walled carbon nanotubes, or multi-walled carbon nanotubes.

After coating the polyester substrate with the mixture of carbon nanotubes in the polymer solution, a polyamide coating may be applied. The polyamide coating may increase ion rejection. The ion rejection with the polyamide coating may be 70% or higher.

FIG. 1B illustrated a schematic of a carbon nanotube based desalination membrane in accordance with an embodiment of the invention. The desalination membrane may include a substrate 102 coated with a mixture 104 of carbon nanotubes in a polymer solution. A polyamide coating 106 may be applied to the coating of the mixture 104. While FIG. 1B illustrates the desalination membrane including the mixture 104 on one side of the substrate 102, it is understood that the substrate 102 may be porous substrate which absorbs the mixture 104 throughout the substrate. The mixture 104 may also be present on both sides of the porous substrate 102. Similarly, the polyamide coating 106 thoroughly coat the mixture 104 and thus may be present throughout the substrate 102 and on both sides of the substrate 102 on top of the mixture 104. The polyamide coating 106 may conformally coat the mixture.

In some embodiments, the polyester substrate coated with the carbon nanotube composite solution may be used as a substrate for depositing additional filtration layers such as polyamide layers and the carbon nanotube layers described below.

### Embodiments Including Mixtures of Carbon Nanotubes in an Aqueous Solution

In some embodiments, a mixture of carbon nanotubes in an aqueous solution may be applied to a polysulfone substrate, a polyamide layer on top of a polysulfonate substrate. The aqueous solution may include a surfactant such as an anionic surfactant, a cationic surfactant, or nonionic surfactant. The sodium dodecyl sulfonate may be of 2% weight concentration. The anionic surfactant may be sodium dodecyl sulfate or sodium dodecylbenzene sulfonate. The cationic surfactant may be quaternary ammonium. The nonionic surfactants may be triton X-100.

The polysulfonate substrate may include polyestersulfone. In some embodiments, the polysulfone substrate may be coated by the carbon nanotubes in the aqueous solution by dipping the polysulfone substrate in the aqueous solution. After the mixture of carbon nanotubes in an aqueous solution is applied to the polysulfonate substrate, the mixture of carbon nanotubes in the aqueous solution may be dried to form a carbon nanotube based layer. In some embodiments, the carbon nanotubes may be single-walled carbon nanotubes, double-walled carbon nanotubes, or multi-walled carbon nanotubes. The carbon nanotubes may be HiPCO produced single-walled carbon nanotubes with smaller diameters which make up a low-density lightweight powder.

In some embodiments, a polyamide coating may be applied to the polysulfone substrate before coating the mixture of carbon nanotubes in the aqueous solution. In some embodiments, a polyamide coating may be applied on top of the coating of the mixture of carbon nanotubes in the aqueous solution.

In some embodiments, carbon nanotubes may be applied inside a polyamide layer. In this instance, a carbon nanotube solution may dissolved in m-phenylenediamine to form a compound solution. An example chemical structure of m-phenylenediamine is illustrated below:

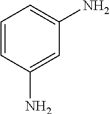

The compound solution may be reacted with trimesoyl chloride to form the polyamide layer with incorporated carbon nanotubes. The trimesoyl chloride may be trimesoyl chloride hexane. An example chemical structure of trimesoyl chloride is illustrated below:

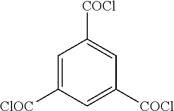

The carbon nanotube polymer solution may form a composite solution which may include a high loading of carbon nanotubes. The loading of carbon nanotubes may be above 1 mg/mL, 10 mg/mL, or 100 mg/mL. In some embodiments, the desalination membranes may be low-density and high strength carbon nanotube polymer desalination membrane integrated into small unit individual person desalination devices. The desalination devices may include low or no power consumption, light-weight, and high mechanic strength at low cost. The carbon nanotubes may be facilely immiscible within a polymer matrix and may be formed into a film which may be manipulated to fabricate desalination membranes which may be used in the desalination devices. The desalination devices may be used with artificial seawater, actual seawater, and brackish water sources.

The carbon nanotubes may be very low-density materials with density of about <1 mg/mL with very strong mechanic strength with Young's module of around 1 TPa. Without limitation to any particular theory, carbon nanotubes may enhance water flow because water is able to flow through the interior of carbon nanotubes resulting in very high membrane permeabilities. However, carbon nanotubes may have superior water channels for ion rejections.

Carbon nanotube based desalination membranes may have superior performance for desalination due to enhanced water permeability, high rejection of ions and chlorophyllin. More significantly, SWCNT membranes may be used in fouling environments such as the oxidative conditions, for example, iodine or chlor-floc treatments.

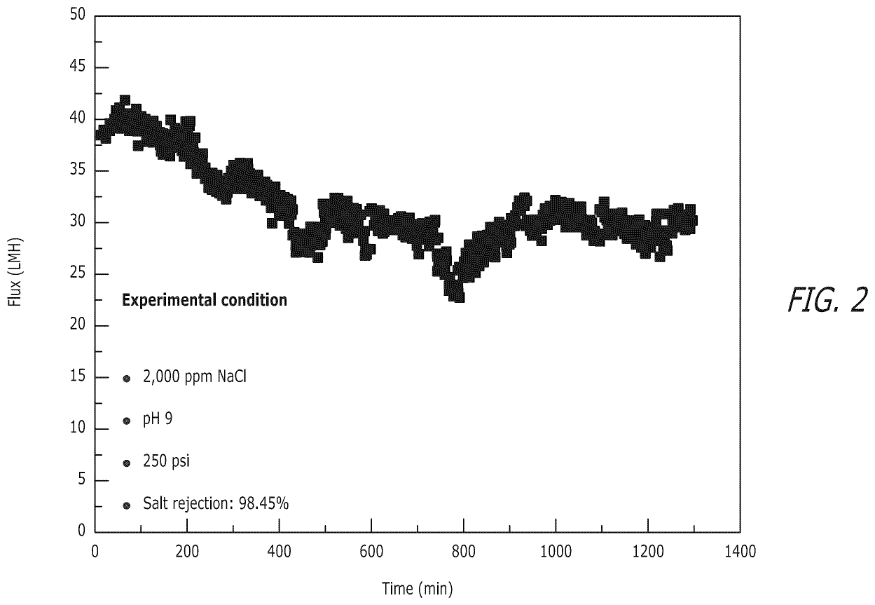

Carbon nanotube based desalination membranes may include a polyester layer, a polysulfone supporting layer, and/or a polyamide layer. Sea water may be pressed through the polyamide layer, the polysulfone layer, and the polyester layer to produce 99.5% ion-rejected water which may be safe for human consumption. FIG. 2 illustrates a plot of flow results from a carbon nanotube based desalination membrane. The carbon nanotube desalination membrane was made from a mixture of carbon nanotubes in an aqueous solution applied to a polysulfone substrate. A polyamide coating was applied on top of the carbon nanotube desalination membrane. The carbon nanotube desalination membrane achieved a 98.45% salt rejection from 2,000 ppm sodium chloride (NaCl) with a pH of 9 at 250 psi. As illustrated, the flux varied from around 25 Liters/m²/hour (LMH) to 40 LMH.

The desalination devices may include such features as low power consumption, light weight, high mechanic strength, and low cost. The desalination device may incorporate a carbon nanotubes based membrane which may include high water permeabilities, high strength, and ultralow density. Instead of multiple layers, a carbon nanotube polymer composite may coat a substrate in a single layer. The substrate may be a polyethersulfonate (PES) membrane cast on a polyester backing. An example chemical structure of polyestersulfonate is illustrated below:

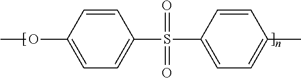

In some embodiments, the substrate may have pores. The pores may be 0.02 microns. The substrate may be made of tricot. Use of a single layer instead of multiple layers may save weight and also may be ⅔ of costs for other desalination membranes. In some embodiments, the carbon nanotube based membrane may include high strength, low density HiPCO SWCNTs. In some embodiments, the HiPCO SWCNT based membrane may include a homogenous polymer composite with high loads of HiPCO SWCNTs. In some embodiments, the carbon nanotube polymer composite may be coated on a substrate forming the membrane. The substrate may be a tricot substrate.

The desalination membrane may include an optimized homogenous carbon nanotube polymer composite. The desalination membrane may include an optimized thickness of carbon nanotube polymer composite coated on a substrate.

Various tasks were performed in producing the carbon nanotube polymer desalination device:

First, the carbon nanotube polymer composites were optimized. This task involves optimizing the ratio of carbon nanotube to polymer (e.g. polyimide), and also the amount of solvent. The carbon nanotubes were homogeneously blended in the polymer matrix (e.g. polyimide). In some embodiments, low density HiPCO SWCNTs of about ≤1 mg/mL may be dispersed in polyimide.

Second, the carbon nanotube polymer composite may be formed into a desalination membrane. The carbon nanotube may be fabricated into a uniform desalination membrane with high water permeabilities and high ionic rejection. The uniformity and thickness may be critical for desalination performance. These physics metrics are commonly determined by the homogeneousness of carbon nanotube polymer composites, the loading of carbon nanotubes, and the concentration of the slurries. HiPCO SWCNTs may include a small diameter which may aid in forming slurries with high uniformity and thickness.

Third, the optimized carbon nanotube polymer desalination membrane may be characterized and tested. The thickness and homogeneousness of the carbon nanotube polymer desalination membrane was characterized using scanning electron microscope images. Additionally, a water desalination tests were run on the carbon nanotube polymer desalination membrane to characterize the water flux, ion rejection, and the pressure. Similarly, the weight and the toughness was tested through impacting the carbon nanotube polymer desalination membrane with a strong force.

Fourth, the optimized carbon nanotube polymer desalination membrane was assembled into a desalination device. The desalination device may be a small unit desalination device for individual personal use. The optimized carbon nanotube polymer desalination membrane was fabricated into a carbon nanotube polymer desalination membrane spiral wound element, and then place inside a housing to form a membrane module. The membrane module may replace a commercial desalination membrane in a small unit desalination device with the assembled carbon nanotube polymer desalination membrane module to test the desalination metrics.

In some embodiments, the carbon nanotube polymer composites may include high loading of carbon nanotube within the polymer and may include excellent immiscibility between the carbon nanotube and the polymer. In some embodiments, the carbon nanotube polymer desalination membrane may include high uniformity and homogeneity. In some embodiments, the carbon nanotube polymer desalination membrane may be light weight and have strong strength. In some embodiments, the carbon nanotube polymer desalination membrane may include high water permeabilities and high water quality using manual operation.

In some embodiments, the carbon nanotube polymer composition is made up of HiPCO SWCNTs mixed with the polymer matrix to form a HiPCO SWCNT polymer slurry. The HiPCO SWCNT polymer slurry may be deposited on a substrate to form a uniform and homogeneous HiPCO SWCNT polymer desalination membrane. In some embodiments, the carbon nanotube polymer composition includes carbon nanotubes mixed with a polyimide or a polysulfone. In some embodiments, surfactant dispersed carbon nanotubes or other soluble carbon nanotubes were added into the polymer to produce the carbon nanotube polymer composite. In some embodiments, the surfactant may be sodium dodecyl sulfonate.

### Carbon Nanotube Polymer Mixtures

Optimized carbon nanotube polymer composites may utilize a mixture of low density, high strength HiPCO SWCNTs, and high young's modulus polymer matrix. The high loading of carbon nanotube in the polymer may be greater than 100 mg/mL and may be homogenously immiscibility. Loading may be defined as the amount of carbon nanotubes which may be integrated into the polymer matrix. HiPCO SWCNTs may be light weight and low density (e.g. about <1 mg/mL). Before mixing within the polymer matrix, carbon nanotubes may form light weight flakes that may fly like ashes. These materials may disperse into polymer syrups.

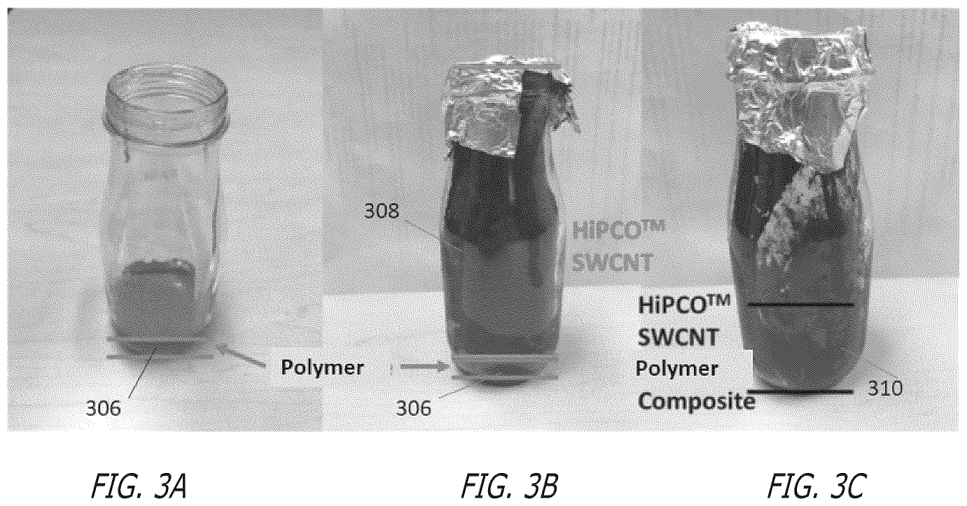

It has been discovered that blending HiPCO SWCNTs in polymer syrups homogeneously, and optimizing the ratio of HiPCO SWCNTs to polymer may maximize water permeabilities and ion rejection. In order to accomplish this, first a polymer matrix is provided. Then, light weight HiPCO SWCNTs are added and stirred with spatulas. FIGS. 3A-3C illustrate various photographs of different stages of forming a carbon nanotube polymer composite slurry in accordance with an embodiment of the invention. FIG. 3A illustrates a jar storing the polymer 306. FIG. 3B illustrates the jar after HiPCO SWCNTs 308 are added on top of the polymer 306. The mixture is then stirred to create a HiPCO SWCNT polymer composite 310. FIG. 3C illustrates the HiPCO SWCNT polymer composite 310 after stirring the carbon nanotubes 308 into the polymer 306.

As discussed previously, there may be advantageous ratios of HiPCO SWCNTs blended with a polymer matrix. For example, a constant volume of polyamide syrup of 10 mL may be applied to various different volumes of carbon nanotubes. The different volumes of carbon nanotubes may be 50 mL, 100 mL, 200 mL, 350 mL, 400 mL, etc. This will make different ratios of polymer matrix to carbon nanotubes.

### Fabrication of Carbon Nanotube Polymer Desalination Membranes

Fabricating the carbon nanotube polymer desalination membrane may include drop casting and die slot coating the HiPCO SWCNT polymer composite. The thickness of HiPCO SWCNT polymer desalination membrane, and the loading of HiPCO SWCNTs may be optimized. It may be advantageous to apply a thinner layer of the carbon nanotube polymer mixture to the substrate in order to aid in flow however thinner layers lead to larger pores which may lead to leakage and poor salt rejection.

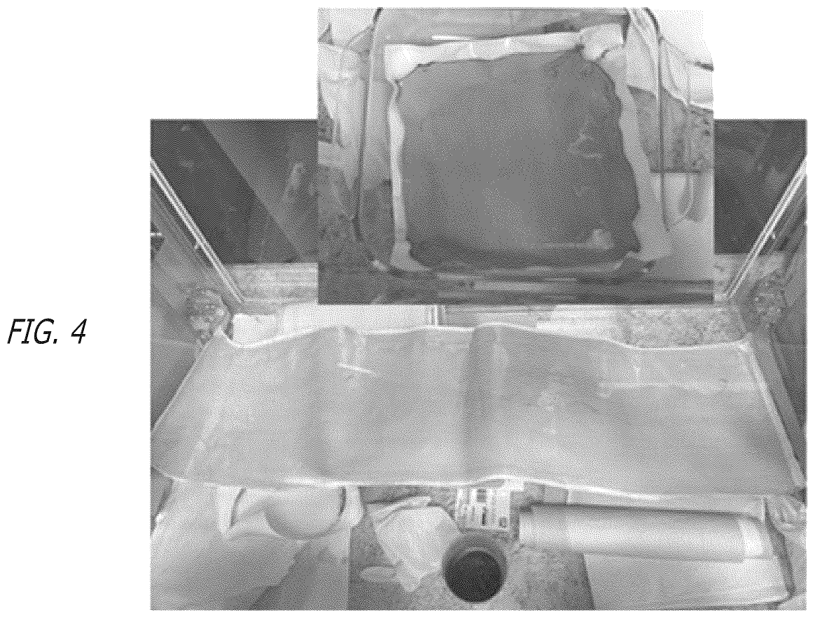

Uniform and homogeneous HiPCO SWCNT polymer desalination membrane may be light weight, high strength, and have a high water permittivity. Carbon nanotubes may enhance the water permeabilities of a polyamide desalination membrane. Further, polyamide membranes containing carbon nanotubes may have >99.5% ion rejections with sustainability to oxidative chemicals like chlorine. However, it may advantageous to fabricate HiPCO SWCNTs polymer desalination membrane without defects which may cause leakage. Different film fabrication methods may be used to fabricate polyamide desalination membranes with minimal defects including drop casting and dieslot coating. The HiPCO SWCNT polymer desalination membrane may be formed various substrates such as tricot film or other polyester, and polypropylene films. FIG. 4 illustrates various photographic images of fabricated carbon nanotube based desalination membranes on various substrates.

### Characterization of Carbon Nanotube Polymer Desalination Membranes

The thickness, homogeneousness, and the loading of the carbon nanotube polymer desalination membrane was characterized using SEM images. Various characteristics of carbon nanotube polymer desalination membrane were evaluated such as water permeabilities, ion rejections, and applied pressure. It was observed that highly uniform carbon nanotube polymer desalination membranes with high carbon nanotubes loading exhibit high water permeabilities and high strength. The water permittivity may be 1 liter/hour/person. It was discovered that the carbon nanotube polymer desalination membranes may tolerate a 6 foot drop to concrete. The carbon nanotube polymer desalination membranes may tolerate 300 lbs dynamic and static compression. The carbon nanotube polymer desalination membranes may exhibit a working temperature from −33° C. to 52° C. The challenges will be to characterize the large size carbon nanotube polymer desalination membranes. For desalination test, one challenge may be the sealing of carbon nanotube polymer desalination membranes and test facilities, and the lifetime of usage.

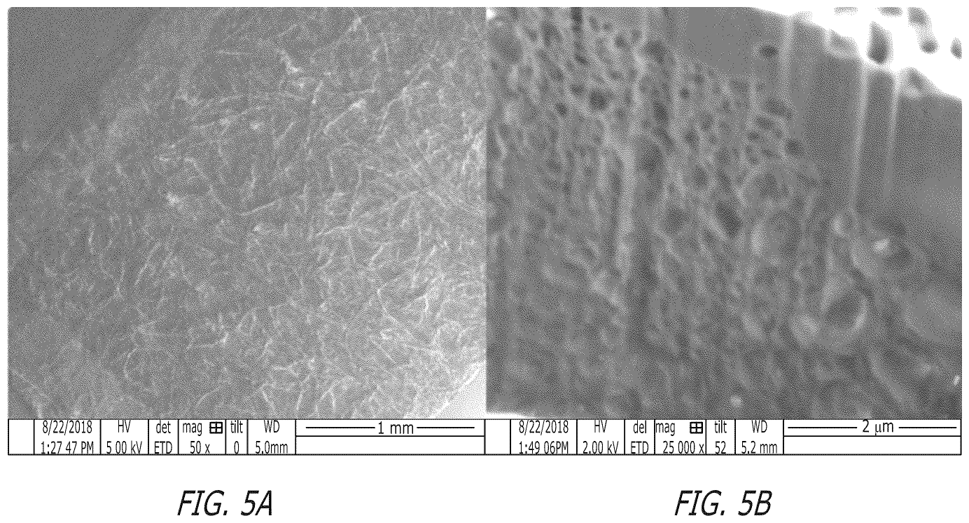

SEM imaging was conducted on a large number of different regions of the carbon nanotube polymer desalination membranes. Based on SEM imaging, a statistical analysis was performed to evaluate the uniformity, homogeneity and the loading information of carbon nanotubes. FIG. 5A illustrates an example SEM image of a carbon nanotube based desalination membrane. The thickness of the carbon nanotube polymer layer may be 200 nm to 500 nm. Focused ion beam (FIB) was used on a cross section of a carbon nanotube polymer desalination membrane to provide the information on the thickness of carbon nanotube polymer desalination membrane. FIG. 5B illustrates an example FIB image on a cross section of a carbon nanotube based desalination membrane. Further characterization techniques that were performed include x-ray tomography and electron tomography to create 3D images of the carbon nanotube polymer desalination membranes to evaluate homogeneity and uniformity evaluations.

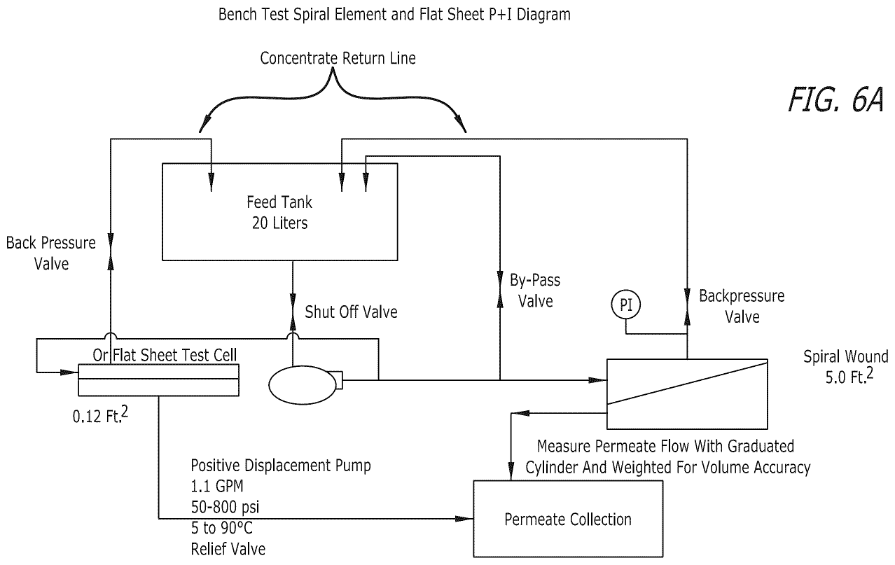

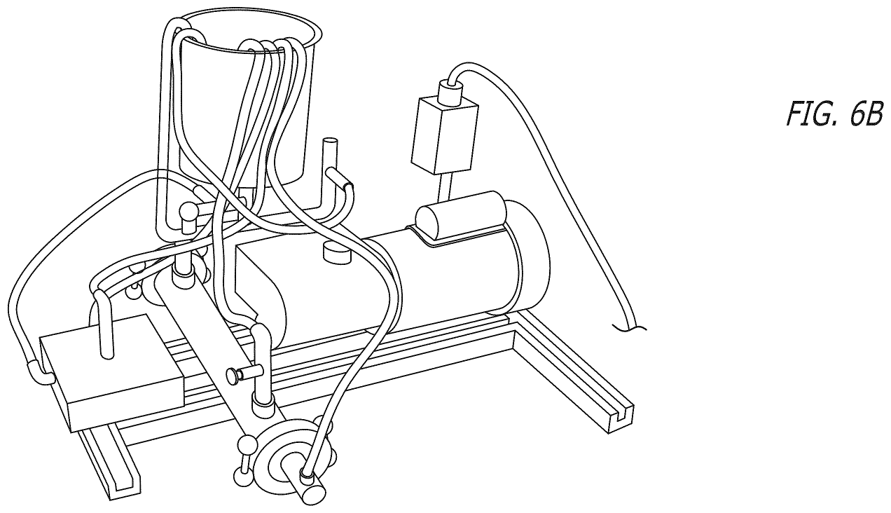

Water desalination testing was performed on the carbon nanotube polymer desalination membranes. FIG. 6A illustrates a diagram of a membrane test system. FIG. 6B illustrates an image of an example membrane test system as illustrated in the diagram of FIG. 6A. For comparison, the flux rate of an example commercial off the shelf membrane is about 6 gallon per square feet per day, however the flux rate of the fabricated carbon nanotube polymer desalination membrane was 18 gallon per square feet per day under 200 psi, which is about three time faster than the commercial off the shelf membrane. The fabricated carbon nanotube desalination membrane may include a filtration amount of 45,050 gallons per day. The fabricated carbon nanotube desalination membrane may include a stabilized salt rejection of greater than 99.99%. The fabricated carbon nanotube desalination membrane may be chlorine tolerant. The fabricated carbon nanotube desalination membrane may be magnesium and calcium selective. The fabricated carbon nanotube desalination membrane may include may achieve filtration at low pressures.

### Example Individual/Small Unit Descalination Devices

Carbon nanotube based desalination membranes were integrated into individual desalination devices. The individual desalination devices may be capable of desalinating 135 Liters per person (up to 9 people) before replacement of any of the elements and/or components. The individual desalination devices may be lightweight, with a total system weight of 16 ounces/person (up to 9 people)—dry weight. The individual desalination devices may be man-portable devices. The individual desalination devices may be produce desalinated water at a flow rate of no less than 1 Liter/hour/person. The individual desalination devices may satisfy a 6 foot drop to concrete and 300 lbs dynamic and static compression while dry. The individual desalination devices may be human powered. In some embodiments, the individual desalination devices may include batteries or other electronic components. If batteries or other electronic components are used, they shall be commercially available and included in the total system weight for the entire Service Life of the unit. The individual desalination devices may be capable of being used and operated with water temperatures from 4° C. to 49° C., in environments with temperature from −33° C. to 52° C. The individual desalination devices may include a treat to drink time of less than 20 minutes with no more than 15 minutes/hour of hands-on time. The individual desalination devices may be compatible with the current IWTD or provide microbiological purification in accordance with NSF Protocol P248.2. The individual desalination devices may eliminate, or be compatible with, systems that remove chemical contamination (e.g. arsenic, chloride, cyanide, magnesium, or sulfate). The individual desalination devices may cost, for one person, <$200 at full scale manufacturing. In some embodiments, the carbon nanotube based desalination membranes may also be integrated into large scale desalination devices which may be used at a desalination plant.

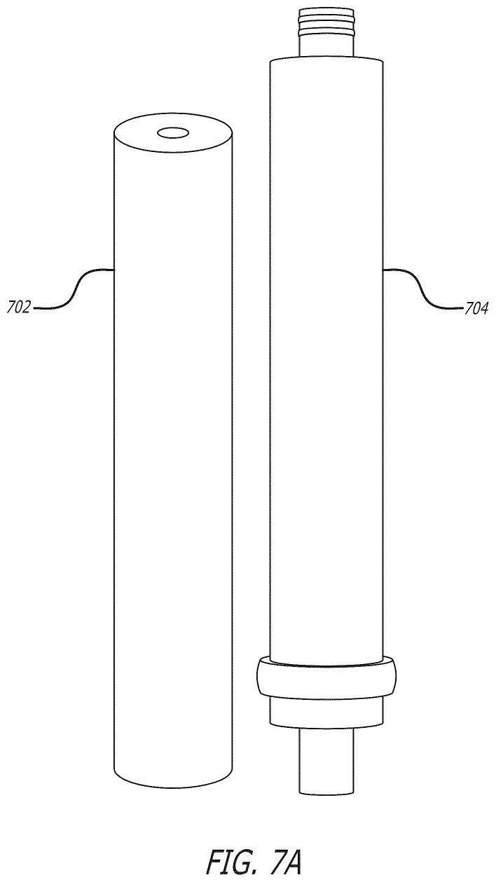

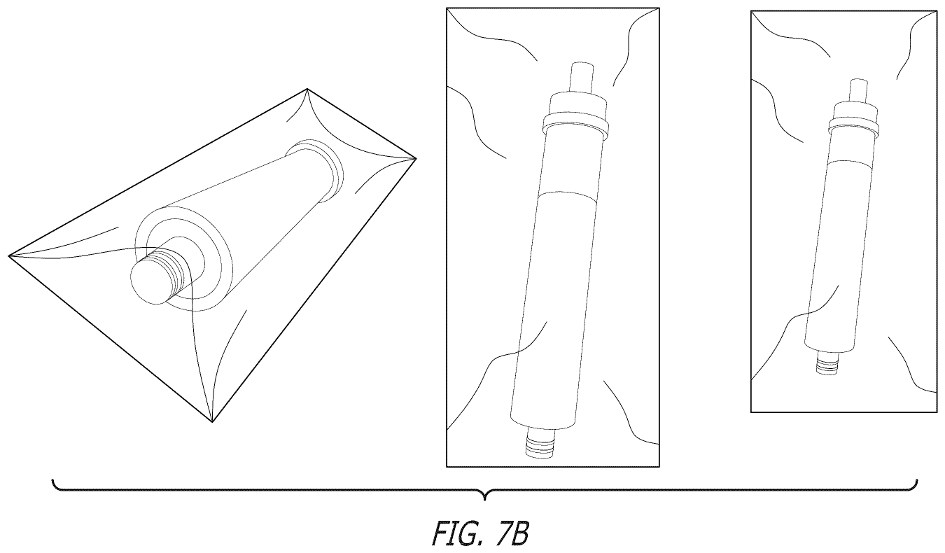

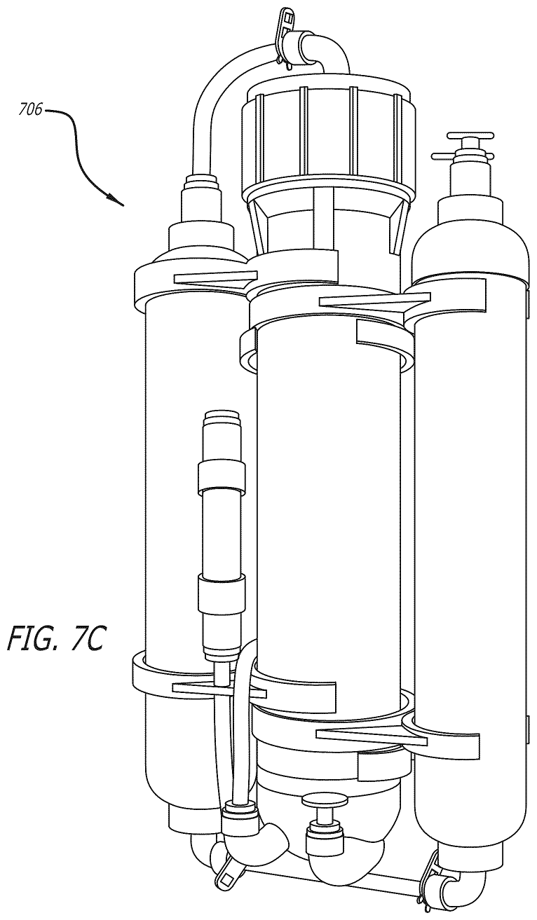

FIG. 7A illustrates an example spiral wound element 702 incorporating a carbon nanotube based desalination membrane. The spiral wound element 702 may be integrated into a desalination cartridge 704. The spiral wound element 702 may integrate any of the carbon nanotube based desalination membranes discussed above. FIG. 7B illustrates various images of a desalination membrane incorporating the spiral wound element 702. FIG. 7C illustrates an example individual desalination device 706 installed with the desalination cartridge 704 described in connection with FIGS. 7A and 7B.

While the filtration membranes are described in the specific application of a desalination membrane, these membranes may also be used as gas filtration membranes and mining treatment membranes.

### Example High Pressure Carbon Monoxide Process

As discussed previously, carbon nanotubes may be produced using HiPCO. These carbon nanotubes may have a small diameter and be low density. An example of this process is described in U.S. Pat. Pub. No. US 2017/0194581 entitled “Electronically Pure Single Chirality Semiconducting Single-Walled Carbon Nanotube for Large Scale Electronic Devices” and filed Oct. 11, 2016 which is hereby incorporated by reference in its entirety. The HiPCO process was developed at Rice University to synthesize SWCNTs in a gas-phase reaction of an iron catalyst such as iron carbonyl with high-pressure carbon monoxide gas. The iron catalyst is used to produce iron nanoparticles that provide a nucleation surface for the transformation of carbon monoxide into carbon during the growth of the nanotubes. The process is run at elevated pressures, e.g., 10-300 atm (10-300 bar), and elevated temperatures, e.g., 900-1100° C., with CO and iron catalyst vapors being continuously fed into the reactor.

According to one or more embodiments, the HiPCO process is operated using feed conditions that favor the production of a single chirality nanotube (e.g., a predetermined/selected chirality). In one or more embodiments, the HiPCO process is modified to enrich the as-grown carbon nanotubes in the CNT of desired chirality. In one embodiment, the HiPCO process is modified to enrich the as-grown carbon nanotubes in (6,5) SWCNTs.

In particular, the HiPCO process can be performed using feed conditions that favor the production of (6,5) SWCNTs. In one exemplary process, conditions include 10 atm (10 bar) and 1100° C. In one or more embodiments, the catalyst is selected to promote the production of a selected chirality, and in particular to promote the production of (6,5) chiral SWCNT. Exemplary catalysts include pentacarbonyliron, pentacarbonylcobalt, pentacarbonylnickel, pentacarbonymolybdenum, and pentacarbonylzirconium. Applicants have surprisingly found that the HiPCO process described herein can be run with low catalyst loads, e.g., <3 wt. The use of low catalyst loads reduces the level of metal impurities that need to be removed in subsequent purification processes and result in a lower metal content in the CNT ink.

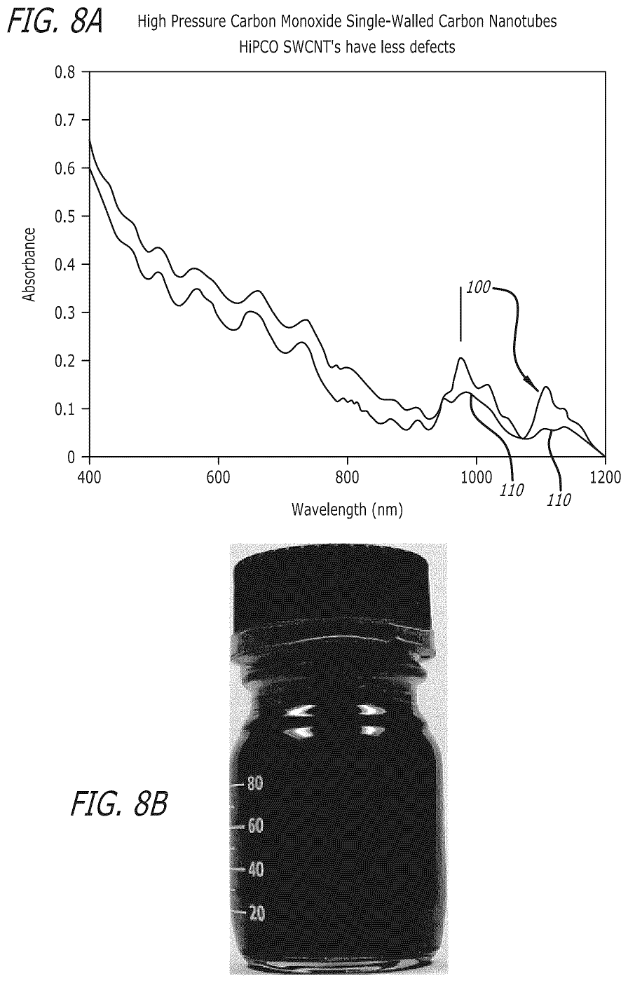

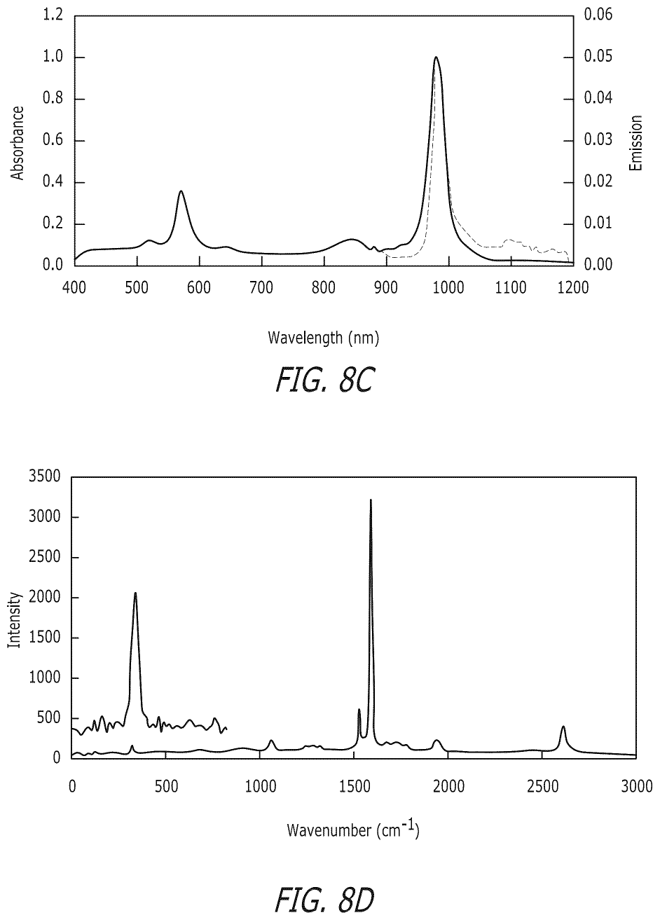

FIG. 8A shows the spectra of as-made HiPCO CNT showing the difference from other HiPCO CNTs. FIG. 8A is a plot of vis (visible)-NIR (near infrared) absorption of a sample prepared according to a process in accordance with some embodiments of the present disclosure, the plot showing SWCNT solution enhanced in (6,5) SWCNTs (shown by arrow), as compared to a conventionally HiPCO processed material. The curve 100 shows increased absorbance in the 980-990 nm and 1100-1200 nm regions, which is indicative of an increase yield of (6,5) SWCNT as compared to a conventionally prepared SWCNT, such as that commercially available from Nanointegris shown as curve 110. The increased intensity of curve 100 between 980-1220 nm demonstrate that the e-CNT ink according to one or more embodiments of the invention is enriched in semiconducting SWCNTs by 2-fold as compared to the conventional CNT solution. Nanointegris 99% CNT inks contain many different species with different diameters and chiralities. In comparison, the electronically pure SWCNT inks only contain one diameter and one chirality.

The as-prepared SWCNTs are then purified to obtain the SWCNT solution. SWCNT raw powder enriched in (6,5) SWCNTs was prepared as described above using a Rice University Mark III high pressure carbon monoxide reactor (Batch number 190.1). The SWCNT raw powder was dispersed in 2% sodium dodecyl sulfate (SDS) aqueous solution (deionized water) using a tip sonicator with 20 Watts of power for 8 hours. After ultracentrifuge or precipitation to remove carbon nanotube bundles and metal nanoparticle catalyst impurities, the decanted supernatant solution was transferred to a Saphacryl S-200 gel column for carbon nanotube separation. The SWCNTs trapped in the gel were eluted out with 2% SDS solution. After 4-6 cycles of gel chromatography, the pure purple solution was collected in a concentration of 6 μg/m L. An image of the purified solution is shown in FIG. 8B, and the purity of the solution was assessed initially using vis (visible)-NIR (near infrared) absorption, NIR fluorescence emission spectra and Raman spectroscopy.

FIG. 8C characterizes the final product with sole diameter of 0.7 nm and one chirality of (6,5). The Vis (visible)-NIR (near infrared) absorption and NIR fluorescence emission spectra of the collected purple solution were recorded on an NS3 Applied Nano Spectralyzer at ambient temperature, and are reported. In the absorption spectrum, two major absorbance peaks at 983 nm (extinction coefficient: 4400 M⁻¹ cm⁻¹) and 570 nm with FWHM (Full Width at Half Maximum) of 30.5 nm and 30 nm, respectively, are assigned to the S₁₁ and S₂₂ transition between the van Hove Singularities of (6,5) chirality SWCNT. A broad band between 800 nm and 880 nm is considered to be the sideband of the S₁₁ transition. When the solution was excited with a 532 nm laser light source, the fluorescence emission was detected as a 986 nm peak with a FWHM of 26.5 nm and a broad band between 1060 nm and 1160 nm, as illustrated by the dashed curve in FIG. 8C. The negligible Stokes shift (3 nm) and narrow FWHM indicate the high purity of (6,5) SWCNT. The solution was further characterized with Raman spectroscopy on an NS3 Applied Nano Spectralyzer, and the corresponding Raman spectrum is shown in FIG. 8D. When the solution was excited with a 532 nm laser beam, the Raman scattering was detected as a strong tangential G band (G from Graphite) at 1587 cm⁻¹ (ω_{G}⁺, 15 cm⁻¹ FWHM) and 1525 cm⁻¹ (ω_{G}⁻³ cm⁻¹ FWHM), a disorder induced D band in the range of 1200-1325 cm⁻¹, a second order overtone G′ at 2617 cm⁻¹, and a weak RBM (Radial Breathing Model) band at 310 cm⁻¹ (d₁=α/ω_{RBM}=248 cm⁻¹ nm/310 cm⁻¹=0.8 nm). These Raman Scattering peaks correspond to sp² carbon-carbon stretching and radial expansion-contraction of (6,5) SWCNT, further corroborating the results of Vis-NIR absorption and NIR fluorescence emission. The peak ratio of D/G is estimated to be 0.03, reflective of less defective (6,5) SWCNT. The D/G ratio provide information about the quality of CNT and the amount of defect sites. The general D/G ratio is greater than 0.1, and the electronically pure SWCNTs exhibit significantly less defects.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1.-27. (canceled)

28. A method for forming a filtration membrane comprising:
providing a polymer matrix;
providing carbon nanotubes, wherein the carbon nanotubes directly contact the polymer matrix;
mixing the carbon nanotubes into the polymer matrix in order to make a homogenous carbon nanotube composite solution; and
coating a substrate with the carbon nanotube composite solution to form a carbon nanotube desalination membrane.

29. The method of claim 28, wherein the polymer matrix comprises polyimide.

30. The method of claim 29, wherein the polyimide comprises m-diaminophenylene.

31. The method of claim 29, wherein the polymer matrix further comprises n-methylpyrrolidone.

32. The method of claim 29, wherein the substrate comprises polyester.

33. The method of claim 32, wherein the substrate comprises polypropylene or polyethylene.

34. The method of claim 28, wherein the polymer matrix comprises polysulfone.

35. The method of claim 34, wherein the polymer matrix further comprises chloroform.

36. The method of claim 34, wherein the substrate comprises polyester.

37. The method of claim 34, wherein the substrate comprises polypropylene or polyethylene.

38. The method of claim 28, wherein the carbon nanotubes are synthesized using a high pressure carbon monoxide process.

39. The method of claim 38, wherein the carbon nanotubes are single walled carbon nanotubes.

40. The method of claim 38, wherein the single walled carbon nanotubes include a small diameter.

41. The method of claim 28, wherein the homogenous carbon nanotube composite solution comprises a slurry.

42. The method of claim 28, further comprising applying a polyamide coating after coating the substrate with the carbon nanotube desalination solution.

43. The method of claim 28, wherein the substrate comprises a tricot film.

44. A method for forming a desalination device comprising:
forming a desalination membrane with the steps of claim 28;
winding the desalination membrane into a spiral membrane wound element; and
installing the spiral membrane wound element into a desalination cartridge.

45.-53. (canceled)
